(19) United States
(12) Patent Application Publication
(10) Pub. No.: US 2020/0287891 A1
(43) Pub. Date: Sep. 10, 2020

(54) ELECTRONIC CERTIFICATE TRANSMISSION METHOD, APPARATUS AND DEVICE

(71) Applicant: ALIBABA GROUP HOLDING LIMITED, GRAND CAYMAN (KY)

(72) Inventors: Jing LI, HANGZHOU (CN); Chunpei FENG, HANGZHOU (CN); Wenbo YANG, HANGZHOU (CN); Mian HUANG, HANGZHOU (CN)

(21) Appl. No.: 16/882,350

(22) Filed: May 22, 2020

Related U.S. Application Data
(63) Continuation of application No. PCT/CN2019/070812, filed on Jan. 8, 2019.

(30) Foreign Application Priority Data
Jan. 12, 2018 (CN) 201810028971.5

(51) Int. Cl. H04L 29/06; H04W 4/80

(52) U.S. Cl. CPC H04L 63/0823; H04W 4/80; H04L 63/126; H04L 63/0876

(57) ABSTRACT

An electronic certificate transmission method, apparatus and device are provided. In a process of obtaining a business service, a first user may perform, using a terminal device through short-range communication, information communication with a terminal device used by a second user to obtain user information of the second user. Then, the first user may send the obtained user information of the second user and identifier information of an electronic certificate of the first user to a business server providing the electronic certificate. The business server may check the user information of the second user and deliver the same electronic certificate to the second user after the verification succeeds, thereby achieving sharing of the electronic certificate.

### CROSS-REFERENCE TO RELATED APPLICATIONS

This application is a continuation application of International Patent Application No. PCT/CN2019/070812, filed on Jan. 8, 2019, which is based on and claims priority of the Chinese Patent Application No. 201810028971.5, filed on Jan. 12, 2018. The above-referenced applications are incorporated herein by reference in their entirety.

### TECHNICAL FIELD

This application relates to the field of computer technologies, and in particular, to an electronic certificate transmission method, apparatus and device.

### BACKGROUND

With rapid development and deployment of information technologies, information-based digital electronic certificates (e.g., digital room card) have been widely used.

Currently, a business provider may provide to a user an electronic certificate corresponding to a business service provided by the business provider, based on which the user can obtain the business service. Taking a digital room card as an example, when a user checks into a hotel, the hotel may send a digital room card to a terminal device used by the user, and the user may directly use the terminal device to perform a card swipe operation on a smart lock of a corresponding hotel room to enter the hotel room.

However, in a scenario in which a same room is shared by multiple users, generally only one terminal device may possess the electronic certificate, which is inconvenient to other users.

In view of the foregoing limitations of existing technologies, a more effective electronic certificate information processing method is desired.

### SUMMARY

Embodiments of this specification provide an electronic certificate transmission method, apparatus and device, to resolve a problem that it is inconvenient to obtain a business service based on an electronic certificate in some business scenarios.

The following technical solutions are adopted in some embodiments of this specification.

From the perspective of a first user, an embodiment of this specification provides an electronic certificate transmission method, including: receiving a sharing operation for an electronic certificate, where the electronic certificate is sent by a business server to a first user in advance; obtaining user information (i.e., identification information) of a second user corresponding to the sharing operation; and sending the obtained user information and identifier information of the electronic certificate to the business server, for the business server to perform matching on the user information according to pre-stored business information and send the electronic certificate to the second user after the matching succeeds.

From the perspective of a business server, an embodiment of this specification further provides an electronic certificate transmission method, including: receiving, by a business server, a verification request sent by a first user, where the verification request includes at least user information of a second user; performing verification on the user information according to pre-stored business information; and when the verification succeeds, identifying a to-be-sent electronic certificate according to identifier information included in the verification request and sending the electronic certificate to the second user.

Correspondingly, from the perspective of a first user, an embodiment of this specification further provides an electronic certificate transmission apparatus, including: an operation receiving module, configured to receive a sharing operation for an electronic certificate, where the electronic certificate is sent by a business server to a first user in advance; an information obtaining module, configured to obtain user information of a second user corresponding to the sharing operation; and a sending module, configured to send the obtained user information and identifier information of the electronic certificate to the business server, for the business server to perform matching on the user information according to pre-stored business information and send the electronic certificate to the second user after the matching succeeds.

From the perspective of a business server, an embodiment of this specification further provides an electronic certificate transmission apparatus, including: a request receiving module, configured to receive a verification request sent by a first user, where the verification request includes at least user information of a second user; a verification module, configured to perform verification on the user information according to pre-stored business information; and a certificate sending module, configured to: when the verification succeeds, identify a to-be-sent electronic certificate according to identifier information included in the verification request and send the electronic certificate to the second user.

Correspondingly, from the perspective of a first user, an embodiment of this specification further provides an electronic certificate transmission device, including: a processor and a memory, where the memory stores an electronic certificate transmission program; and the processor executes the electronic certificate transmission program stored in the memory and performs the following operations: receiving a sharing operation for an electronic certificate, where the electronic certificate is sent by a business server to a first user in advance; obtaining user information of a second user corresponding to the sharing operation; and sending the obtained user information and identifier information of the electronic certificate to the business server, for the business server to perform matching on the user information according to pre-stored business information and send the electronic certificate to the second user after the matching succeeds.

From the perspective of a business server, an embodiment of this specification further provides an electronic certificate transmission device, including: a processor and a memory, where the memory stores an electronic certificate transmission program; and the processor invokes the electronic certificate transmission program stored in the memory and performs the following operations: receiving a verification request sent by a first user, where the verification request includes at least user information of a second user; performing verification on the user information according to pre-stored business information; and when the verification succeeds, identifying a to-be-sent electronic certificate according to identifier information included in the verification request and sending the electronic certificate to the second user.

This specification further provides an electronic certificate transmission method. The method may include: sending, from a server, an electronic certificate to a first terminal device of a first user; receiving, from the first terminal device and by the server, a verification request, wherein the verification request may include identification information of a second user and identifier information of the electronic certificate, and wherein the identification information of the second user may be obtained by the first terminal device from a second terminal device of the second user through short-range communication including near field communication, Bluetooth communication, radio frequency identification communication, or infrared communication; conducting, by the business server and according to pre-stored user identification information on the server, a verification of the identification information of the second user; and identifying, in response to the verification being successful, the electronic certificate according to the identifier information in the verification request, and sending the electronic certificate to the second user.

This specification further provides an electronic certificate transmission apparatus. The apparatus may include a processor and a non-transitory computer-readable memory coupled to the processor and configured with instructions executable by the processor to: send an electronic certificate to a first terminal device of a first user; receive, from the first terminal device, a verification request, wherein the verification request may include identification information of a second user and identifier information of the electronic certificate, and wherein the identification information of the second user may be obtained by the first terminal device from a second terminal device of the second user through short-range communication including near field communication, Bluetooth communication, radio frequency identification communication, or infrared communication; conduct, according to pre-stored user identification information, a verification of the identification information of the second user; and identify, in response to the verification being successful, the electronic certificate according to the identifier information in the verification request, and send the electronic certificate to the second user.

This specification further provides a non-transitory computer-readable storage medium. The medium may have instructions stored thereon executable by a processor to cause the processor the perform operations. The operations may include: sending, from a server, an electronic certificate to a first terminal device of a first user; receiving, from the first terminal device and by the business server, a verification request, wherein the verification request may include identification information of a second user and identifier information of the electronic certificate, and wherein the identification information of the second user may be obtained by the first terminal device from a second terminal device of the second user through short-range communication including near field communication, Bluetooth communication, radio frequency identification communication, or infrared communication; conducting, by the server and according to pre-stored user identification information on the business server, a verification of the identification information of the second user; and identifying, in response to the verification being successful, the electronic certificate according to the identifier information in the verification request, and sending the electronic certificate to the second user.

At least one of the foregoing technical solutions adopted in some embodiments of this specification can achieve the following beneficial effects.

In a process of obtaining a business service, a first user who has obtained an electronic certificate may share the electronic certificate. In particular, the first user may perform, using a terminal device through short-range communication, information communication with a terminal device used by a second user to obtain user information of the second user. Then, the first user may simultaneously send the obtained user information of the second user and identifier information of the electronic certificate of the first user to a business server providing the electronic certificate. Thus, the business server may check the user information of the second user and deliver the same electronic certificate to the second user after the verification succeeds, thereby achieving sharing of the electronic certificate. In the foregoing manner, the electronic certificate can be shared to meet requirements of a plurality of users for a business service, and security of the electronic certificate can also be effectively ensured.

### BRIEF DESCRIPTION OF THE DRAWINGS

The accompanying drawings described herein are used for providing further understanding for this specification and constitute a part of this specification. Exemplary embodiments of this specification and descriptions thereof are used for explaining this specification and do not constitute an improper limitation to this specification.

FIG. 1 is a schematic diagram of an actual application scenario to which an electronic certificate transmission method according to an embodiment of this specification is applicable.

FIG. 2 is a schematic diagram of a transmission process of an electronic certificate based on a first user side according to an embodiment of this specification.

FIG. 3 is a schematic diagram of a transmission process of an electronic certificate based on a business server side according to an embodiment of this specification.

FIGS. 4A, 4B, and 4C are schematic diagrams of a transmission process of a digital room card in actual application according to an embodiment of this specification.

FIG. 5 is a schematic structural diagram of an electronic certificate transmission apparatus based on a first user side according to an embodiment of this specification.

FIG. 6 is a schematic structural diagram of an electronic certificate transmission apparatus based on a business server side according to an embodiment of this specification.

### DETAIL DESCRIPTION OF THE EMBODIMENTS

To make the objectives, technical solutions, and advantages of this specification clearer, the following clearly and completely describes the technical solutions of this specification with reference to specific embodiments of this specification and the corresponding accompanying drawings. Apparently, the described embodiments are only some embodiments rather than all the embodiments of this specification. All other embodiments obtained by a person of ordinary skill in the art based on the embodiments of this specification without creative efforts shall fall within the protection scope of this specification.

Conventionally, in a business scenario, a business provider may send a business-related electronic certificate only to a user who has sent a business request. However, in some business scenarios, multiple users may jointly obtain a same business service. In this case, these users can use only one electronic certificate to obtain the business service, which is inconvenient to these users.

For example, when a user checks into a hotel, the hotel may send a digital room card of a specified room to a booking user, who may use the digital room card, through a terminal device, to unlock a smart door lock of a corresponding room to enter the room. However, if multiple users check into the same room, other users can only use the digital room card on the terminal device of the booking user to perform a card swiping operation.

In view of the foregoing limitations, this specification provides an information processing method based on an electronic certificate. In some business scenarios, through a sharing operation of a holder of an electronic certificate, the same electronic certificate may be sent to one or more verified users, so that multiple users who have jointly obtained a same business service can each obtain the same electronic certificate.

In some embodiments of this specification, the electronic certificate may include, but not limited to: a digital door card, a bus card, a bank card, a membership card, a coupon, a movie ticket, a discount coupon, and/or the like. The electronic certificate may be delivered by a server of the business provider to a terminal device used by the user. In this specification, a server of the business provider may be referred to as a “business server.”

FIG. 1 is a schematic diagram of an application scenario to which an information processing method according to an embodiment of this specification is applicable.

In FIG. 1, a business server may provide an electronic certificate to a user. Generally, the business server may be a server in a back-end of a business provider. The business provider may include, but not limited to, merchants such as a shop, a hotel, a restaurant, a cafe, a gas station, and a cinema, or service providers such as a telecom operator or a website.

In some embodiments of this specification, the business server may alternatively be a server of a business platform. In other words, business services from various business providers may be aggregated on the business platform, and a user may obtain business services provided by different business providers through the business platform. Correspondingly, the electronic certificate for the user will be provided by the server of the business platform.

The business server may adopt an architecture such as a single server, a clustered server, or a distributed server, which is not specifically limited herein.

As shown in FIG. 1, a first user may have obtained an electronic certificate and may share the electronic certificate with a second user. This may be specifically implemented through a terminal device used by the first user (i.e., a first terminal device).

As shown in FIG. 1, the second user may receive the electronic certificate shared by the first user. Similarly, in specific implementation, the second user may also receive the shared electronic certificate through a terminal device used by the second user (i.e., a second terminal device). Generally, the second user and the first user may jointly obtain a same business service. For example, the second user may be a guest user who shares a same hotel room with a booking user (i.e., the first user).

In some embodiments of this specification, the terms “first user” and “second user” may each refer to an individual user. In some other embodiments of this specification, the terms “first user” and “second user” may each include, but not limited to, an individual user, a terminal device used by a user, or an account used by the user. This should not constitute a limitation on this specification.

The terminal device may include, but not limited to, a smartphone, a smart watch, a tablet, a smart wearable device, or the like. In some embodiments of this specification, the terminal device may have a short-range communication function such as near field communication (NFC), Bluetooth communication, or radio frequency identification (RFID).

In addition, in the application scenario shown in FIG. 1, there may be one first user, and there may be one or more second users.

Based on the architecture shown in FIG. 1, the technical solutions provided in some embodiments of this specification will be described in details below.

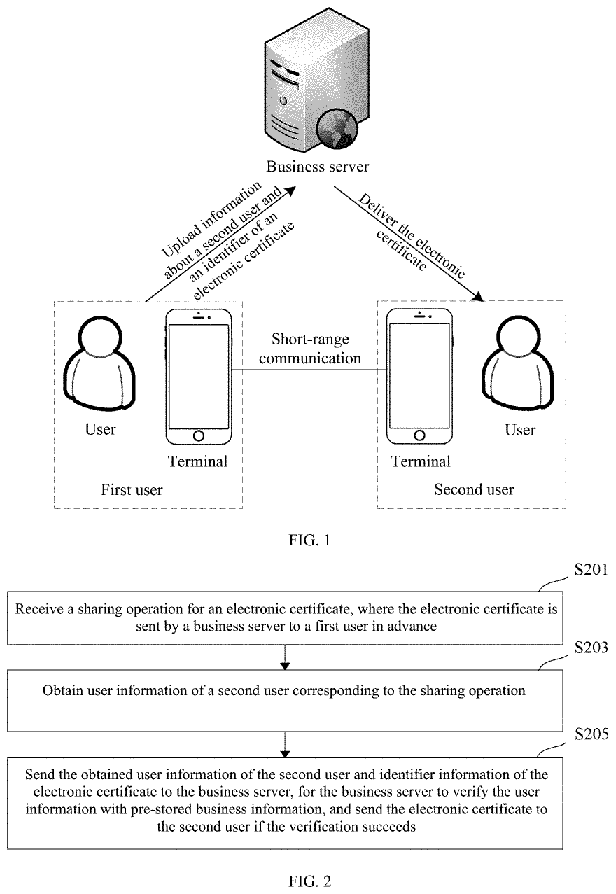

From a perspective of the first user, this specification provides an information processing method based on an electronic certificate. As shown in FIG. 2, the method may include the following steps.

In step S201, a sharing operation for an electronic certificate may be received. The electronic certificate may be sent by a business server to a first user in advance (i.e., a terminal device of the first user).

In some embodiments of this specification, the first user may obtain the electronic certificate through a plurality of manners. Two common implementations will be described below as examples.

The first manner may be implemented through online transaction. The first user may access a business interface (usually in a form of an application page or a web page) of the business server through a corresponding application or browser, and order a business service in the business interface. In the order process, the first user may need to provide user information such as a mobile phone number and a business account. Therefore, the business server may send the corresponding electronic certificate to the first user based on the user information provided by the first user. In this specification, “user information” of a user may also be referred to as “identification information” or “user identification information” of a user, which may include, but not limited to, name, ID number, address, and mobile phone number of a user.

The second manner may be implemented through offline transaction. The first user may obtain a business service offline (e.g., reserve a hotel room). Similarly, the first user may provide user information of the first user to a business provider. Further, the business provider may upload the user information to the business server, so that the business server may generate the electronic certificate and send the electronic certificate to the first user.

Upon obtaining the electronic certificate, the first user may share the electronic certificate with other users who have obtained the same business service. That is, the first user may perform the sharing operation for the electronic certificate.

To perform the sharing operation, the first user may use a terminal device to enter a corresponding sharing interface and perform the sharing operation. Specific manners may include, but not limited to, clicking, dragging, flicking, and/or pressing. In some embodiments of this specification, when the first user enters the sharing interface through the terminal device, the terminal device may trigger a short-range communication function such as NFC, Bluetooth communication, or RFID.

In step S203, user information of a second user corresponding to the sharing operation may be obtained.

As described above, the terminal device used by the first user may obtain the user information of the second user through a terminal device used by the second user with the support of the foregoing short-range communication technology (the terminal devices usually need to be within a communication range of each other). The user information described herein may include, but not limited to, a mobile phone number, an account name, an electronic business card, or an identity number of the second user.

In step S205, the obtained user information of the second user and identifier information of the electronic certificate may be sent to the business server. The business server may verify the user information of the second user with pre-stored business information, and send the electronic certificate to the second user if the verification succeeds. The verification may be conducted by comparing the user information of the second user with user information included in the pre-stored business information. If the user information of the second user has a match with user information included in the pre-stored business information (i.e., pre-stored user identification information), the verification succeeds; otherwise, the verification fails.

In this step, the identifier information of the electronic certificate may include, but not limited to, a serial number, an identification number (ID), a bar code of the electronic certificate. Generally, the identifier information may be generated by the business server, and may uniquely identify an electronic certificate. If the verification on the user information succeeds, the business server may search for the same electronic certificate based on the identifier information and send the electronic certificate to the second user.

As described above, to perform sharing operation for the electronic certificate, the first user may need to access an interface of the electronic certificate on the terminal device. Thus, the terminal device may establish a network connection with the business server. In some embodiments of this specification, the obtained user information of the second user and the identifier information of the electronic certificate of the first user may be sent, through the terminal device, to the business server through the network connection in a form of a verification request.

Thus, in some embodiments of this specification, the first user does not directly share the electronic certificate with the second user. Instead, the electronic certificate is sent to the second user from the business server.

According to the foregoing steps, in a process of obtaining a business service, a first user who has obtained an electronic certificate may share the electronic certificate. In particular, using a terminal device and through short-range communication, the first user may communicate with a terminal device used by a second user to obtain user information of the second user. Then, the first user may simultaneously send the obtained user information of the second user and identifier information of the electronic certificate of the first user to a business server providing the electronic certificate. The business server may verify the user information of the second user and deliver the same electronic certificate to the second user after the verification succeeds, thereby allowing the electronic certificate being shared with the second user. In the foregoing manner, the electronic certificate may be shared with multiple users of a business service, while effectively ensuring the security of the electronic certificate.

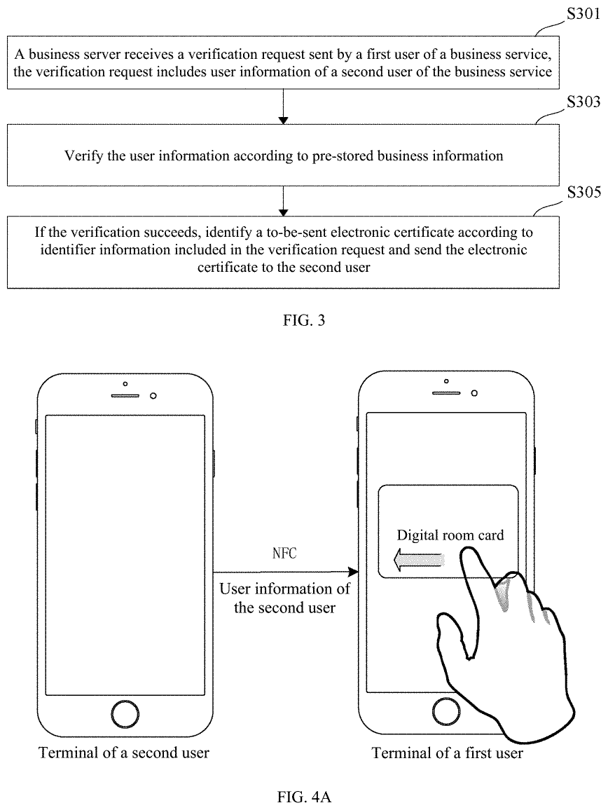

The foregoing embodiments are based on the description from the perspective of the first user. From a perspective of the business server, this specification further provides an electronic certificate transmission method. As shown in FIG. 3, the method may include the following steps.

In step S301, a business server may receive a verification request sent by a first user of a business service. The verification request may include user information of a second user of the business service.

As described above, the first user may send the obtained user information of the second user and identifier information of an electronic certificate of the first user to the business server in a form of a verification request.

In step S303, the user information may be verified according to pre-stored business information.

In an actual application scenario, the business server may generally store corresponding business information in advance according to a business request of a user. The pre-stored business information may include user information of potential users who may need to use a business service.

The business information herein may include, but not limited to, a business type, a business identifier (a business order number, a serial number), information of the business provider, and information of a user using the business service (i.e., user identification information of a user using the business service).

In one possible implementation, the business information may be stored in a business reservation. For example, the first user may make a business reservation (e.g., reservation of a hotel room, a movie ticket, or a concert ticket) in advance. In a process of the service reservation, the user may enter the user information of related second user (e.g., user information of multiple occupants or attendees who will use the business service). Further, the business server may store the foregoing user information.

In another possible implementation, the business information may not be stored in a business reservation. Instead, the second user may perform business registration/check in before obtaining the business service. In a hotel check-in scenario, the second user may register at a hotel front desk, and correspondingly the hotel may upload the user information registered by the second user to the business server.

In the foregoing two implementations, user information of a user who can obtain the business service may be stored in the business server, and the business server may verify the user information included in the verification request (i.e., user information of the second user) sent by the first user. More specifically, if the user information included in the verification request has a match with user information included in the pre-stored user information, the verification succeeds; otherwise, the verification fails.

If the verification succeeds, step S305 may be performed. If the verification fails, the business server may not send the electronic certificate to the second user.

In step S305, upon a successful verification, a to-be-sent electronic certificate may be identified according to identifier information included in the verification request, and the electronic certificate may be sent to the second user.

The electronic certificate of the first user may be generated by the business server. Thus, the business server may find the corresponding electronic certificate according to the identifier information and send the electronic certificate to the second user.

The user information of the second user included in the verification request may include, but not limited to, account information, a mobile phone number of the second user. Therefore, the business server may send the electronic certificate to the second user according to the user information.

From a perspective of the second user, a terminal device used by the second user may send the user information of the second user to a terminal device used by the first user through short-range communication, and the second user may subsequently obtain the electronic certificate of the first user provided by the business server. Related contents in the foregoing description may be referred to for details of the process, which are not repeatedly described herein for the sake of conciseness.

A scenario in which the first user and the second user check into a hotel will be used as an example in the following to further illustrate some embodiments of this specification.

In this scenario, it is assumed that the first user has obtained an electronic certificate (i.e., a digital room card). To conveniently share the digital room card, the first user and the second user may use terminal devices such as mobile phones to perform information communication through an NFC function.

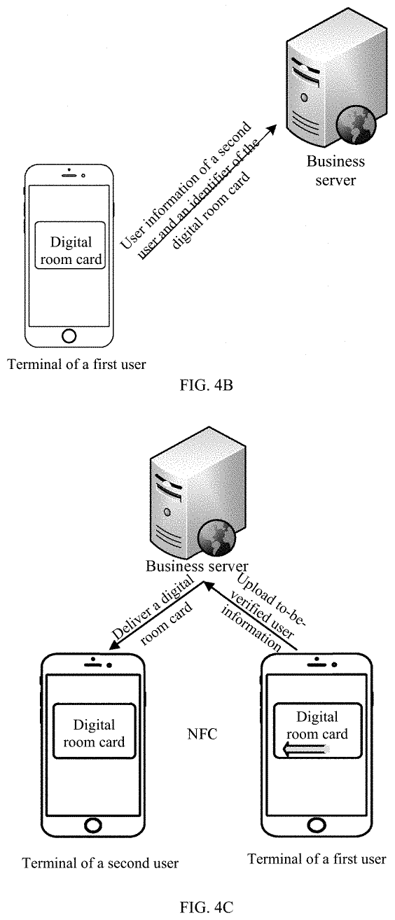

As shown in FIG. 4A, the first user may use a mobile phone to enter an interface of the digital room card, and conduct a sharing operation for the digital room card in the interface (e.g., slide the digital room card on the interface, as shown in FIG. 4A). In this case, the mobile phone of the first user may obtain user information such as a mobile phone number and an account name of the second user from a terminal device of the second user with the support of the NFC function.

In this case, as shown in FIG. 4B, the mobile phone used by the first user may send identifier information of the digital room card and the user information of the second user to the business server. The business server may verify the user information of the second user according to the pre-recorded business information.

As shown in FIG. 4C, after the verification succeeds, the server may send the digital room card of the first user to the second user (either to a business account or a mobile phone of the second user).

In actual application, the foregoing process may not be perceived by the second user. In other words, in a short-range communication range, after the first user conducts the sharing operation for the digital room card through the mobile phone, the mobile phone used by the second user can immediately display that the digital room card has been obtained.

Then, the second user may use the digital room card through the mobile phone of the second user. That is, the second user may use the mobile phone to perform a card swipe operation (based on the NFC function) on a smart lock of a corresponding room, and may smoothly unlock the door.

Certainly, the methods in some embodiments of this specification may be applicable to other electronic certificates that can be shared (e.g., a movie ticket, a coupon, and a discount card), and the details are not repeatedly described herein for the sake of conciseness.

According to the electronic certificate transmission method in some embodiments of this specification, a same electronic certificate can be conveniently shared among multiple users who obtain a same business service. Compared with traditional short-distance information transmission, the sharing of the electronic certificate in the foregoing methods is more secure and reliable.

Based on a same inventive concept, this specification further provides a corresponding electronic certificate transmission apparatus.

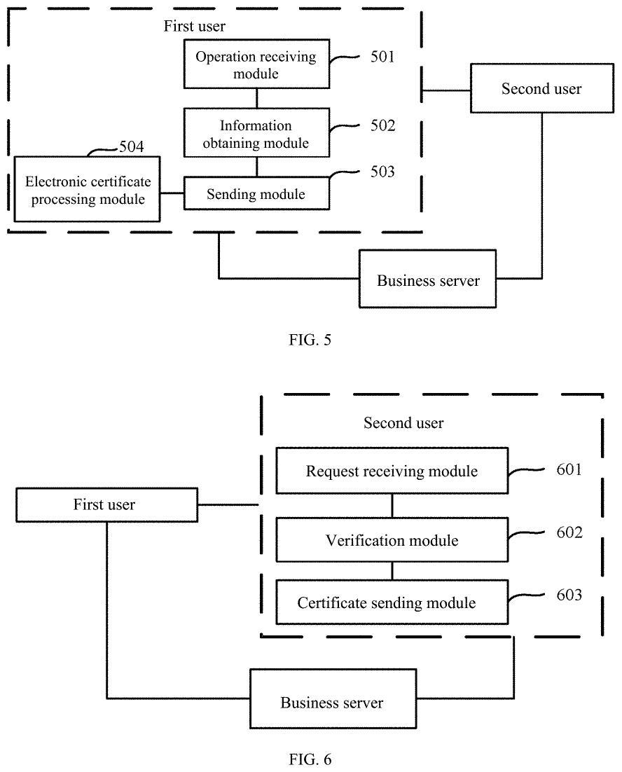

As shown in FIG. 5, from the perspective of the first user of a business service, the electronic certificate transmission apparatus provided in some embodiments of this specification may include an operation receiving module 501, an information obtaining module 502, a sending module 503.

The operation receiving module 501 may be configured to receive a sharing operation for an electronic certificate. The electronic certificate may be sent by a business server to a first user in advance.

The information obtaining module 502 may be configured to obtain user information of a second user of the business service corresponding to the sharing operation.

The sending module 503 may be configured to send the obtained user information and identifier information of the electronic certificate to the business server, for the business server to conduct a verification of the user information according to pre-stored business information, and send the electronic certificate to the second user if the verification is successful. The verification may be conducted by finding a match of the user information in the pre-stored business information.

The apparatus may further include an electronic certificate processing module 504. The electronic certificate processing module 504 may be configured to send, to the business server, a business request including user information of the first user, and receive the electronic certificate generated and delivered by the business server based on the user information.

The information obtaining module 502 may obtain the user information of the second user corresponding to the sharing operation through short-range communication.

The short-range communication may include, but not limited to, near field communication, Bluetooth communication, radio frequency identification communication, or infrared communication. The user information may include, but not limited to, a mobile phone number or a business account.

The information obtaining module 502 may determine that a user in a short-range communication range as the second user corresponding to the sharing operation, and obtain the user information of the second user through the short-range communication.

Based on the apparatus shown in FIG. 5, in actual application, the apparatus may be implemented by a hardware device (e.g., a terminal device). In particular, the device may include a processor and a memory.

The memory may store an electronic certificate transmission program, and the processor may invoke the electronic certificate transmission program stored in the memory and perform operations.

The operations may include: receiving a sharing operation for an electronic certificate, where the electronic certificate is sent by a business server to a first user in advance; obtaining user information of a second user corresponding to the sharing operation; and sending the obtained user information and identifier information of the electronic certificate to the business server, for the business server to match the user information according to pre-stored business information and send the electronic certificate to the second user if a match is found.

As shown in FIG. 6, from a perspective of a business server, this specification further provides an electronic certificate transmission apparatus. The apparatus may include a request receiving module 601, a verification module 602, and a certificate sending module 603.

The request receiving module 601 may be configured to receive a verification request sent by a first user. The verification request may include at least user information of a second user.

The verification module 602 may be configured to verify the user information according to pre-stored business information. The verification may be conducted by comparing the user information of the second user with user information included in the pre-stored business information.

The certificate sending module 603 may be configured to: upon a successful verification, identify a to-be-sent electronic certificate according to identifier information included in the verification request and send the electronic certificate to the second user.

The verification module 602 may match and verify the user information of the second user according to user information included in the pre-stored business information. If the user information of the second user is consistent with (i.e., matching) the pre-stored user information, the verification module 602 may determine that the verification succeeds. Otherwise, the verification module 602 may determine that the verification fails.

If the user information of the second user includes a mobile phone number, the certificate sending module 603 may send the electronic certificate to the mobile phone number in a form of a short message. If the user information of the second user includes a business account, the certificate sending module 603 may send the electronic certificate to the business account.

Based on the apparatus shown in FIG. 6, in actual application, the apparatus may be implemented by a hardware device (e.g., a terminal device or a server). In particular, the device may include a processor and a memory.

The memory may store an electronic certificate transmission program, and the processor may invoke the electronic certificate transmission program stored in the memory and perform operations.

In some embodiments, the operations may include: receiving a verification request sent by a first user, where the verification request includes at least user information of a second user; verifying the user information according to pre-stored business information; and, upon a successful verification, identifying a to-be-sent electronic certificate according to identifier information included in the verification request and sending the electronic certificate to the second user.

In some embodiments, the operations may include: sending, from a business server, an electronic certificate for a business service to a first terminal device for a first user of the business service; receiving, from the first terminal device and by the business server, a verification request, wherein the verification request includes user information of a second user of the business service and identifier information of the electronic certificate, and wherein the user information of the second user is obtained by the first terminal device from a second terminal device for the second user through short-range communication comprising near field communication, Bluetooth communication, radio frequency identification communication, or infrared communication; conducting, by the business server and according to pre-stored business information on the business server, a verification of the user information of the second user; and identifying, in response to the verification being successful, the electronic certificate of the business service according to the identifier information in the verification request, and sending the electronic certificate to the second user.

The embodiments in this specification are all described in a progressive manner, descriptions of each embodiment may focus on difference aspects from other embodiments, relevant descriptions of these embodiments may be referred to for same or similar parts in the embodiments. More specifically, apparatus, device, and medium embodiments are similar to method embodiments, and therefore are described briefly. Relevant descriptions in the method embodiments may be referred to for related parts, details of which are not repeatedly described herein for the sake of conciseness.

This concludes the descriptions for specific embodiments of this description. Other embodiments may fall within the scope of the appended claims. In some embodiments, the steps recorded in the claims may be performed in different sequences and an expected result may still be achieved. In addition, the processes depicted in the accompanying drawings do not necessarily require specific sequences or consecutive sequences to achieve an expected result. In some embodiments, multitask processing and parallel processing may be advantageous.

In the 1990s, improvements of a technology can be clearly distinguished between hardware improvements (for example, improvements to a circuit structure such as a diode, a transistor, a switch, etc.) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented by using a hardware entity module. For example, a programmable logic device (PLD) such as a field programmable gate array (FPGA) is a type of integrated circuit whose logic function is determined by a user by programming the device. The designers perform voluntary programming to “integrate” a digital system into a single PLD without requiring a chip manufacturer to design and prepare a dedicated integrated circuit chip. In addition, instead of making an integrated circuit chip manually, the programming is mostly implemented by using “logic compiler software, which is similar to the software compiler used to write programs. Original code before compiling is also written in a specific programming language, which is referred to as Hardware Description Language (HDL). There are many types of HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc. Currently, Very-High-Speed Integrated Circuit Hardware Description Language (VHDL) and Verilog are most commonly used. A person skilled in the art should also understand that as long as a method procedure is logically programmed and then programmed to an integrated circuit by using the foregoing hardware description languages, a hardware circuit that implements the logical method procedure can be easily obtained.

The controller can be implemented in any suitable manner, for example, the controller can take the form of, for example, a microprocessor or processor and a computer-readable medium storing computer-readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20 and Silicone Labs C8051F320. The memory controller can also be implemented as part of the memory control logic. A person skilled in the art will also appreciate that, in addition to implementing the controller in the form of pure computer-readable program code, it is also possible to implement the controller in the form of a logic gate, switch, application-specific integrated circuit, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module or the unit described in the foregoing embodiments can be specifically implemented by a computer chip or an entity or implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, in implementation of this specification, the function of the units may be implemented in a same piece of or multiple pieces of software and/or hardware.

A person skilled in the art should understand that some embodiments of this specification may be provided as a method, a system, or a computer program product. Therefore, this specification may use a form of hardware only embodiments, software only embodiments, or embodiments with a combination of software and hardware. Moreover, this specification may use a form of a computer program product that is implemented on one or more computer-usable storage media (including but not limited to a disk memory, a CD-ROM, an optical memory, and the like) that include computer-usable program code.

This specification is described with reference to the flowchart and/or block diagram of the method, device (system), and computer program product of some embodiments of this specification. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can guide a computer or another programmable data processing device to work in a specific manner, so that the instructions stored in the computer readable memory generate a product including an instruction apparatus, where the instruction apparatus implements functions specified in one or more procedures in the flowcharts and/or one or more blocks in the block diagrams.

These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the block diagrams.

In a typical configuration, the computer device includes one or more processors (CPUs), an input/output interface, a network interface, and a memory.

The memory may include a form such as a persistent memory, a random-access memory (RAM) and/or a non-volatile memory of computer readable media, for example, a read-only memory (ROM) or a flash memory (RAM). The memory is an example of the computer readable medium.

The computer readable medium includes a persistent medium and a non-persistent medium, a removable medium and a non-removable medium, which may implement storage of information by using any method or technology. The information may be a computer readable instruction, a data structure, a module of a program or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition in this disclosure, the computer-readable medium does not include transitory computer readable media (transitory media), such as a modulated data signal and a carrier.

It should also be noted that the terms “include”, “comprise” and any other variants mean to cover the non-exclusive inclusion. Thereby, the process, method, article, or device which include a series of elements not only include those elements, but also include other elements which are not clearly listed, or include the inherent elements of the process, method, article and device. Without further limitation, the element defined by a phrase “include one” does not exclude other same elements in the process, method, article or device which include the element.

A person skilled in the art should understand that some embodiments of this specification may be provided as a method, a system, or a computer program product. Therefore, this specification may use a form of hardware only embodiments, software only embodiments, or embodiments with a combination of software and hardware. In addition, this specification may use a form of a computer program product implemented on one or more computer available storage media (including but not limited to a disk memory, a CD-ROM, an optical memory, and the like) including computer available program code.

This specification can be described in the general context of computer executable instructions executed by a computer, for example, a program module. Generally, the program module includes a routine, a program, an object, a component, a data structure, and the like for executing a particular task or implementing a particular abstract data type. This specification can also be practiced in a distributed computing environment in which tasks are performed by remote processing devices that are connected through a communication network. In a distributed computing environment, the program module may be located in both local and remote computer storage media including storage devices.

The embodiments in this specification are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The foregoing descriptions are merely embodiments of this specification and are not intended to limit this specification. For a person skilled in the art, various modifications and variations can be made to this specification. Any modification, equivalent replacement, or improvement made without departing from the spirit and principle of this specification shall fall within the scope of the claims of this specification.

What is claimed is:

1. An electronic certificate transmission method, comprising:
sending, from a server, an electronic certificate to a first terminal device of a first user;
receiving, from the first terminal device and by the server, a verification request, wherein the verification request includes identification information of a second user and identifier information of the electronic certificate, and wherein the identification information of the second user is obtained by the first terminal device from a second terminal device of the second user through short-range communication comprising near field communication, Bluetooth communication, radio frequency identification communication, or infrared communication;
conducting, by the server and according to pre-stored user identification information on the server, a verification of the identification information of the second user; and
identifying, in response to the verification being successful, the electronic certificate according to the identifier information in the verification request, and sending the electronic certificate to the second user.

2. The method of claim 1, wherein the sending an electronic certificate to a first terminal device of a first user comprises:
receiving, by the server and from the first terminal device, a request including identification information of the first user;
generating, based on the identification information of the first user, the electronic certificate; and
sending the electronic certificate to the first terminal device.

3. The method of claim 1, further comprising: before receiving a verification request:
determining, by the first terminal device, the second terminal device within a short-range communication range of the first terminal device; and
obtaining, through the short-range communication, the identification information of the second user from the second terminal device.

4. The method of claim 1, wherein the identification information of the second user includes: a mobile phone number, an account name, an electronic business card, or an identity number of the second user.

5. The method of claim 4, wherein the identifier information of the electronic certificate includes a serial number, an identification number, or a bar code of the electronic certificate.

6. The method of claim 1, wherein the conducting a verification of the identification information of the second user comprises:
conducting a comparison of the identification information of the second user with the pre-stored user identification information;
determining, in response to the identification information of the second user having a match in the pre-stored user identification information, the verification succeeds; and
determining, in response to the identification information of the second user not having a match in the pre-stored user identification information, the verification fails.

7. The method of claim 1, wherein the sending the electronic certificate to the second user comprises:
sending, in response to the identification information of the second user including a mobile phone number, the electronic certificate to the mobile phone number in a form of a short message; and
sending, in response to the identification information of the second user including a business account, the electronic certificate to the business account.

8. An electronic certificate transmission apparatus, comprising a processor and a non-transitory computer-readable memory coupled to the processor and configured with instructions executable by the processor to:
send an electronic certificate to a first terminal device of a first user;
receive, from the first terminal device, a verification request, wherein the verification request includes identification information of a second user and identifier information of the electronic certificate, and wherein the identification information of the second user is obtained by the first terminal device from a second terminal device of the second user through short-range communication comprising near field communication, Bluetooth communication, radio frequency identification communication, or infrared communication;
conduct, according to pre-stored user identification information, a verification of the identification information of the second user; and
identify, in response to the verification being successful, the electronic certificate according to the identifier information in the verification request, and send the electronic certificate to the second user.

9. The apparatus of claim 8, wherein to send an electronic certificate to a first terminal device of a first user, the memory is further configured with instructions executable by the processor to:
receive, from the first terminal device, a request including identification information of the first user;
generate, based on the identification information of the first user, the electronic certificate; and
send the electronic certificate to the first terminal device.

10. The apparatus of claim 8, wherein to obtain the identification information of the second user, the first terminal device is configured to:
determine the second terminal device within a short-range communication range of the first terminal device; and
obtain, through the short-range communication, the identification information of the second user from the second terminal device.

11. The apparatus of claim 8, wherein the identification information of the second user includes: a mobile phone number, an account name, an electronic business card, or an identity number of the second user.

12. The apparatus of claim 11, wherein the identifier information of the electronic certificate includes a serial number, an identification number, or a bar code of the electronic certificate.

13. The apparatus of claim 8, wherein to conduct a verification of the identification information of the second user, the memory is further configured with instructions executable by the processor to:
conduct a comparison of the identification information of the second user with the pre-stored user identification information;
determine, in response to the identification information of the second user having a match in the pre-stored user identification information, the verification succeeds; and
determine, in response to the identification information of the second user not having a match in the pre-stored user identification information, the verification fails.

14. The apparatus of claim 8, wherein to send the electronic certificate to the second user, the memory is further configured with instructions executable by the processor to:
send, in response to the identification information of the second user including a mobile phone number, the electronic certificate to the mobile phone number in a form of a short message; and
send, in response to the identification information of the second user including a business account, the electronic certificate to the business account.

15. A non-transitory computer-readable storage medium having instructions stored thereon executable by a processor to cause the processor the perform operations, comprising:
sending, from a server, an electronic certificate to a first terminal device of a first user;
receiving, from the first terminal device and by the server, a verification request, wherein the verification request includes identification information of a second user and identifier information of the electronic certificate, and wherein the identification information of the second user is obtained by the first terminal device from a second terminal device for the second user through short-range communication comprising near field communication, Bluetooth communication, radio frequency identification communication, or infrared communication;
conducting, by the server and according to pre-stored user identification information on the server, a verification of the identification information of the second user; and
identifying, in response to the verification being successful, the electronic certificate according to the identifier information in the verification request, and sending the electronic certificate to the second user.

16. The non-transitory computer-readable storage medium of claim 15, wherein the sending an electronic certificate to a first terminal device of a first user comprises:
receiving, by the server and from the first terminal device, a request including identification information of the first user;
generating, based on the identification information of the first user, the electronic certificate; and
sending the electronic certificate to the first terminal device.

17. The non-transitory computer-readable storage medium of claim 15, wherein the operations further comprise: before receiving a verification request,
determining, by the first terminal device, the second terminal device within a short-range communication range of the first terminal device; and
obtaining, through the short-range communication, the identification information of the second user from the second terminal device.

18. The non-transitory computer-readable storage medium of claim 15, wherein the identification information of the second user includes: a mobile phone number, an account name, an electronic business card, or an identity number of the second user.

19. The non-transitory computer-readable storage medium of claim 18, wherein the identifier information of the electronic certificate includes a serial number, an identification number, or a bar code of the electronic certificate.

20. The non-transitory computer-readable storage medium of claim 15, wherein the conducting a verification of the identification information of the second user comprises:
conducting a comparison of the identification information of the second user with the pre-stored user identification information;
determining, in response to the identification information of the second user having a match in the pre-stored user identification information, the verification succeeds; and
determining, in response to the identification information of the second user not having a match in the pre-stored user identification information, the verification fails.
